(19) United States
(12) Patent Application Publication
(10) Pub. No.: US 2013/0055764 A1
(43) Pub. Date: Mar. 7, 2013

(54) CRYSTAL GROWTH FURNACE AND MOVING METHOD THEREOF

(71) Applicant: Wen-Yuan Chang, Zhunan Township (TW)

(72) Inventor: Wen-Yuan Chang, Zhunan Township (TW)

(73) Assignee: REAL GREEN MATERIAL TECHNOLOGY CORP., Zhunan Township (TW)

(21) Appl. No.: 13/226,327

(22) Filed: Sep. 6, 2011

(51) Int. Cl. C03B 5/42; C03B 35/00; C03B 5/167

(52) U.S. Cl. 65/27; 65/361; 65/158; 65/356; 65/33.1

(57) ABSTRACT

A crystal growth furnace is disclosed herein and includes a top cover, a body and a bottom portion. The top cover is configured to be moved by a top cover shifting mechanism. The body is configured to be moved vertically by a body shifting mechanism. The bottom portion is configured to be moved from the bottom of the crystal growth furnace by a bottom portion shifting mechanism and used to carry a crucible. When the top cover, the body and the bottom portion are connected together to be the crystal growth furnace, a silicon material disposed within the crucible is grown to be an ingot.

### BACKGROUND OF THE INVENTION

1. Field of the Invention

The present invention is related to a crystal growth furnace, and more particularly to a crystal growth furnace with a top cover, a body and a bottom portion configured for engineers to conveniently remove ingots and maintain.

2. Description of the Prior Art

Silicon material is the raw material of the monocrystalline silicon or the multicrystalline silicon in the solar battery. The conversion efficiency of the monocrystalline silicon is better than the multicrystalline silicon. The purity requirement in the multicrystalline silicon is lower than the purity requirement in the monocrystalline silicon, so the manufacture cost of the multicrystalline silicon is cheaper than the manufacture cost of the monocrystalline silicon. Because the conversion efficiency of the multicrystalline silicon is lower than but close to the monocrystalline silicon, the solar battery made by the multicrystalline silicon dominates the market of the solar energy.

FIG. 1 is a view of a conventional crystal growth furnace. As shown in FIG. 1, the crystal growth furnace 2′ includes a furnace chamber 21′, a bottom portion 22′ and a hoist device 14′. The bottom portion 22′ includes a top opening 221′. The hoist device 14′ is configured to drive the bottom portion 22′ alternatively move up or down for the top opening 221′ to close to/move off the opening 111′ of the top board 11′. The top chamber 21′ includes a bottom opening 211′ and the bottom opening 211′ is corresponding to cover the opening 111′ of the top board 11′. Therefore, when the bottom portion 22′ is driven to move up by the hoist device 14′, the bottom portion 22′ and the top camber 21′ are connected together to be the crystal growth furnace 2′ and there is an internal space formed inside the crystal growth furnace 2′.

However, there are several drawbacks in the conventional crystal growth furnace 2′ described above.

(A) The top chamber 21′ of the crystal growth furnace 2′ is too deep for engineers to do the prevent maintenance. The engineers have to be inside the top chamber 21′ to do the prevent maintenance and it is very inconvenience.

(B) After the ingot is generated in the furnace 2′, the engineers have to manipulate the hoist device 14′ to drive the bottom portion 22′ to move down and the crucible is able to move out from the heating room 4′ by a crucible removing machine. It is really not convenience.

(C) The crystal growth furnace 2′ is configured to grow the 450 Kg ingot. If the crystal growth furnace 2′ would like to grow an 800 Kg ingot, the space of the crystal growth furnace 2′ is too narrow for the crucible moving machine to transport the crucible and it is easy to hit the edge of the crystal growth furnace 2′ so as to cause the damage of the crystal growth furnace 2′ or the crucible 46′.

Therefore, a need is arisen to develop a new furnace to overcome those drawbacks described above and engineers are easy to move the crucible in and out of the furnace.

### SUMMARY OF THE INVENTION

The main object of the present invention is to provide a crystal growth furnace and the crystal growth furnace includes a top cover, a body and a bottom portion. In addition, the top cover, the body and the bottom portion are respectively moved by the top cover shifting mechanism, the body shifting mechanism and the bottom portion shifting mechanism. Therefore, the top cover can be moved to a maintain zone and the bottom portion can be moved away from the body of the crystal growth furnace. Engineers are easy to do the maintaining jobs and the crucible is convenient to be removed from the bottom portion of the crystal growth furnace.

Therefore, according to the object described above, a crystal growth furnace is disclosed herein and includes a top cover, a body and a bottom portion. The top cover is configured to be moved by a top cover shifting mechanism. The body is configured to be moved vertically by a body shifting mechanism. The bottom portion is configured to be moved from the bottom of the crystal growth furnace by a bottom portion shifting mechanism and used to carry a crucible. When the top cover, the body and the bottom portion are connected together to be the crystal growth furnace, a silicon material disposed within the crucible is grown to be an ingot. When the top cover, the body and the bottom portion are connected together to be the crystal growth furnace, a silicon material disposed within the crucible is grown to be an ingot. When the bottom portion is moved from the bottom of the crystal growth furnace by the bottom portion shifting mechanism and the ingot grown within the crucible is removable.

Another object of the present invention is to provide a moving method of the crystal growth furnace, and engineers are easy to manipulate the crystal growth furnace to move the top cover, the body and the bottom portion

In order to achieve another object of the present invention, a moving method of the crystal growth furnace is disclosed herein and includes the following steps: the step of moving a bottom portion at the bottom of the crystal growth furnace by a bottom portion shifting mechanism; the step of vertically moving a body by a body shifting mechanism to connect with and separate from the bottom portion; the step of moving a top cover by a top cover shifting mechanism at the top of the crystal growth furnace and a maintain zone; the step of connecting the bottom portion, the body and the top cover to grow a silicon material; and the step of separating the bottom portion and the body to take out an ingot generated within a crucible.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view illustrating a conventional crystal growth furnace in prior art;

FIG. 2 is a view illustrating a crystal growth furnace in the present invention;

FIG. 3A, FIG. 3B and FIG. 3C are views illustrating the moving steps of the crystal growth furnace in the present invention;

FIG. 4 is a view illustrating a bottom cover in the present invention; and

FIG. 5 is a flow chart illustrating a moving method of the crystal growth furnace in the present invention.

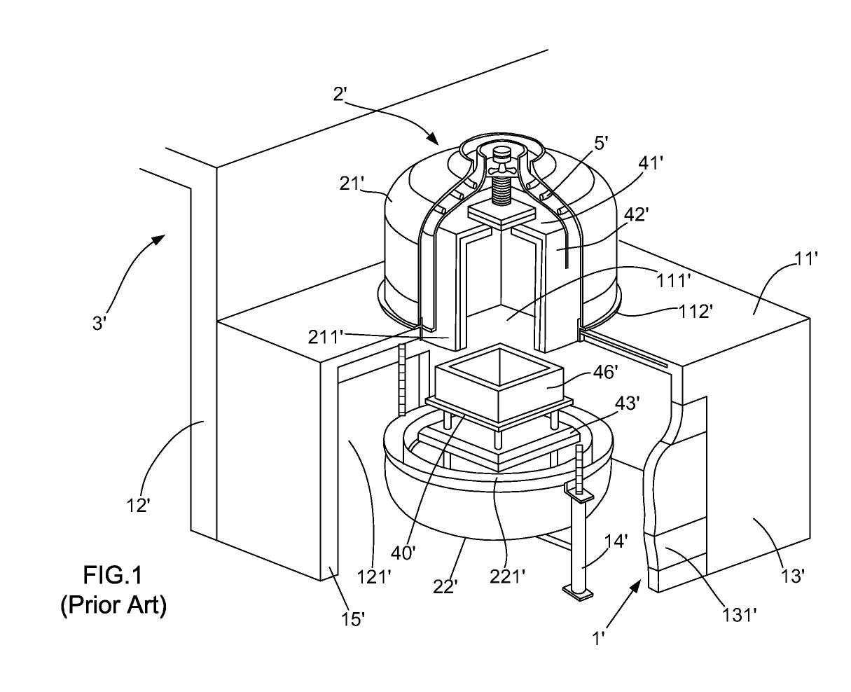

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

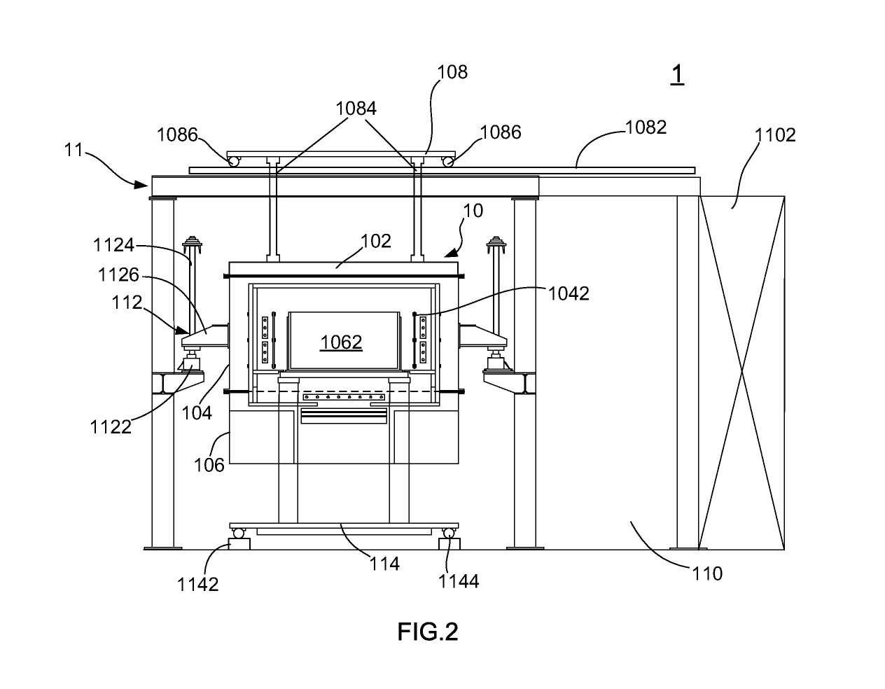

Please referring to FIG. 2, it is a view illustrating a crystal growth furnace in the present invention. As shown in FIG. 2, the crystal growth furnace 10 in a crystal growth system 1 includes a top cover 102, a body 104 and a bottom portion 106. There are several heating device 1042 disposed in the body 104. In order to heat the crystal growth furnace 10 evenly, in a different embodiment of the present invention, the heating devices 1042 are not only disposed in the body 104 but also in the top cover 102 and the bottom portion 106, and the temperature is able to increase rapidly and the crucible 1062 is able to be heated evenly. The function of the bottom portion 106 is to carry the crucible 1062. The top cover 102 is able to move away from the top of the crystal growth furnace 10 by the top cover shifting mechanism 108. The top cover shifting mechanism 108 includes a first transporting element 1082 and a shifting device 1084. The shifting device 1084 of the top cover shifting mechanism 108 is configured to separate the top cover 102 and the body 104. The top cover 102 will be transported to the maintain zone 110 by the first transporting element 1082 of the top cover shifting mechanism 1082. The body shifting mechanisms 112 are respectively disposed at two sides of the crystal growth furnace 10 and connected to the body 104. In the present embodiment, there are two body shifting mechanisms 112. However, there are more than two body shifting mechanisms 112 in a different embodiment, and it is not limited herein. In the preferred embodiment of the present invention, the body shifting mechanism 112 includes at least one motor 1122, at least one transporting axis 1124 and at least one driving device 1126. The transporting axis 1124 is connected to the motor 1122 and the driving devices 1126 are disposed at two sides of the body 104 and drive the driving device 1126 to move. Subsequently, the driving device 1126 will drive the body 104 to move.

The bottom portion shifting mechanism 114 is disposed at the bottom of the crystal growth furnace 10 and connected to the bottom portion 106. The second transporting element 1084 will move the bottom portion 106 and the bottom portion 106 is going to move out from the crystal growth furnace 10. In the embodiment of the present invention, the first transporting element 1082 and the second transporting element 1142 are trail tracks. The top cover shifting mechanism 108 and the bottom portion shifting mechanism 114 respectively includes a plurality of first wheels 1086 and a plurality of second wheels 1144 and the first wheels 1086 and the second wheels 1144 are respectively operated in accordance with the first transporting element 1086 and the second transporting element 1144. In addition, the first transporting element 1082 and the second transporting element 1142 are guiding channels and the top cover shifting mechanism 108 and the bottom shifting mechanism 114 respectively include guiding wheels operated in accordance with the first transporting element 1082 and the second transporting element 1142. However, the first transporting element 1082 and the second transporting element 1142 are operated in accordance with a transporting axis 1124 in a different embodiment, and it is not limited herein.

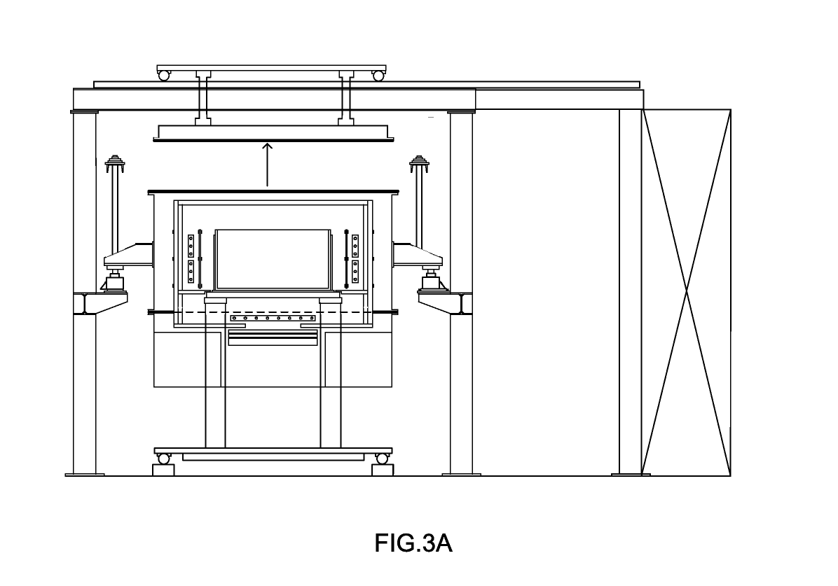

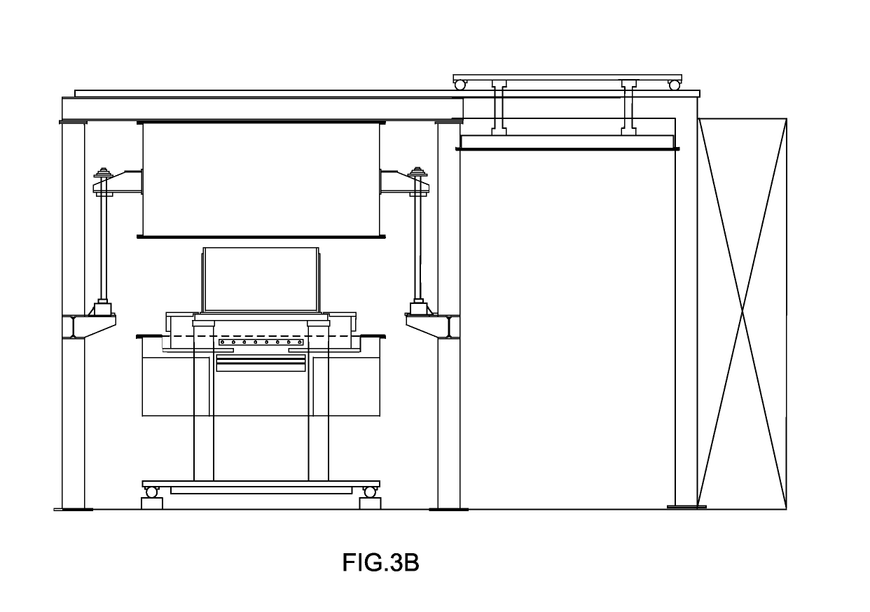

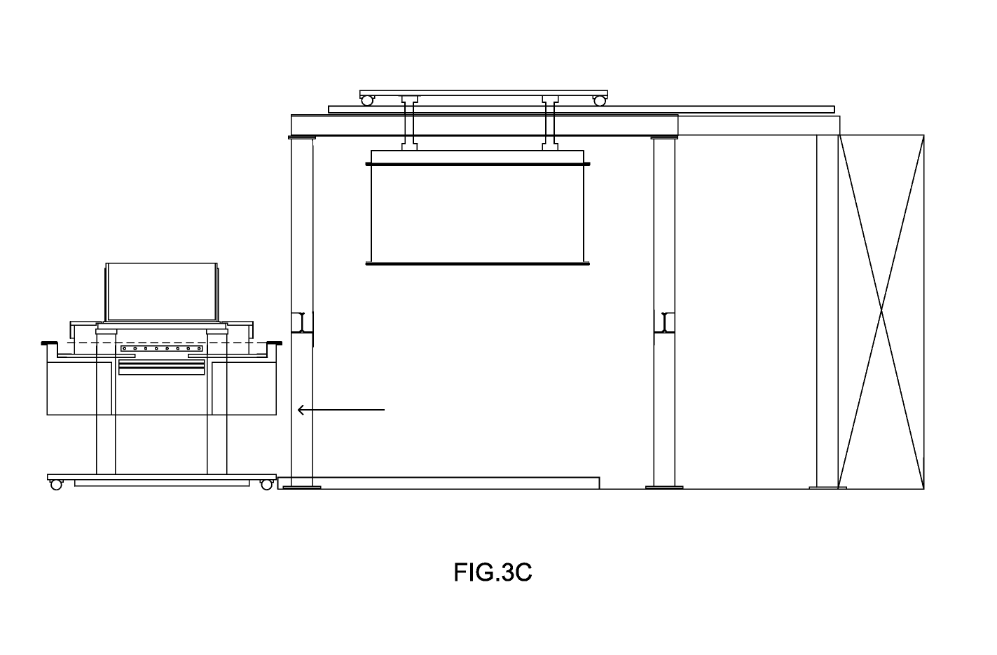

Therefore, the basic structure of the crystal growth furnace 10 in the present invention is disclosed in the description above, and the moving method of the crystal growth furnace 10 will describe at the following chapter. Please still referring to FIG. 2, FIG. 3A, FIG. 3B and FIG. 3C at the same time, and those are the drawings described the moving method of the crystal growth furnace 10. In order to avoid too many element numbers shown in the drawings, and there is no any element number marked in FIG. 3A, FIG. 3B and FIG. 3C and those element numbers are shown in FIG. 2 only. As shown in FIG. 2, when the top cover 102, the body 104 and the bottom portion 106 are connected together to be the crystal growth furnace 10, the silicon material within the crucible 1062 is able to grow to be an ingot. After growing the silicon material to be the ingot, as shown in FIG. 3A, sequentially, the top cover shifting mechanism 108 will move the top cover 102 up in accordance with the shifting device 1084 and the top cover 102 are separated from the body 104. The top cover shifting mechanism 108 will move the top cover 102 away from the crystal growth furnace 10. When the top cover shifting mechanism 108 would like to move the top cover 102 away from the crystal growth furnace 10, the top cover 102 will vertically move away from the body 10 by the top cover shifting mechanism 108. When the top cover 102 moves away from the body 104, the top cover shifting mechanism 108 will move the top cover 102 horizontally from the top of the crystal growth furnace 10 to the top of the maintain zone 110.

Subsequently, after the top cover 102 is shifted to the top of the maintain zone 110, as shown in FIG. 3B, the motor 1122 of the body shifting mechanism 112 is rotated to drive the driving device 1126 and the body 104 to move up in accordance with the transporting axis 1124. At final, as shown in FIG. 3C, the bottom portion 106 is pushed to shift on the second transporting element 114 so as to move away from the crystal growth furnace 10. Therefore, the ingot generated in the crucible 1062 is easy to move away, and the engineer is able to replace the crucible 1062 with a new one and the crystal growth furnace 10 is ready for the next silicon material growing procedure.

In other word, as shown in FIG. 3B, it should be noted that the engineers is able to do the maintain procedure from the people assistant element 1102 when the top cover 102 is shifted to the top of the maintain zone 110. Moreover, in the structure of the crystal growth furnace 10 of the present invention, the people assistant element 1102 is an elevator, an escalator, a traditional scaling ladder and a ladder according to the requirement of the manufacture. In the present embodiment, the model of the people assistant element 1102 is not limited.

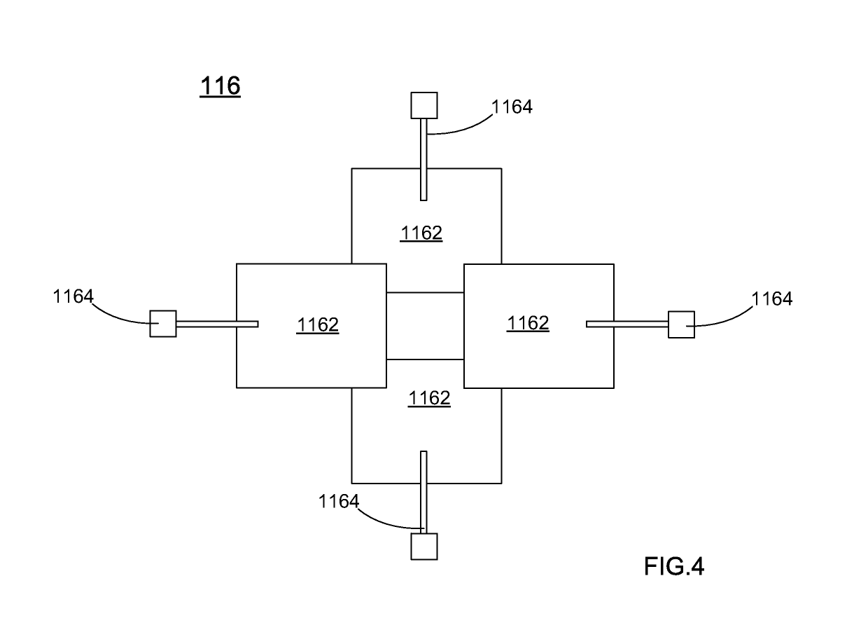

FIG. 4 is a view illustrating a bottom cover in the present invention. As shown in FIG. 4, during the silicon growing procedure, it is necessary to release the heat within the internal region of the crystal growth furnace 10, and the lower area of the bottom portion 106 includes a bottom cover 116. The bottom cover 116 is made by a plurality of gates 1162 and the gates 1162 are opened and closed in accordance with the date driving machine 1164. In the structure of the crystal growth furnace 10 of the present invention, the purpose of the design of the bottom cover 116 is to release the high temperature gas in the crystal growth furnace 10 so as to reduce the temperature after the silicon material is heated and the gates 1162 is opened in accordance with the gate driving machine 1164 by operating the bottom portion 106.

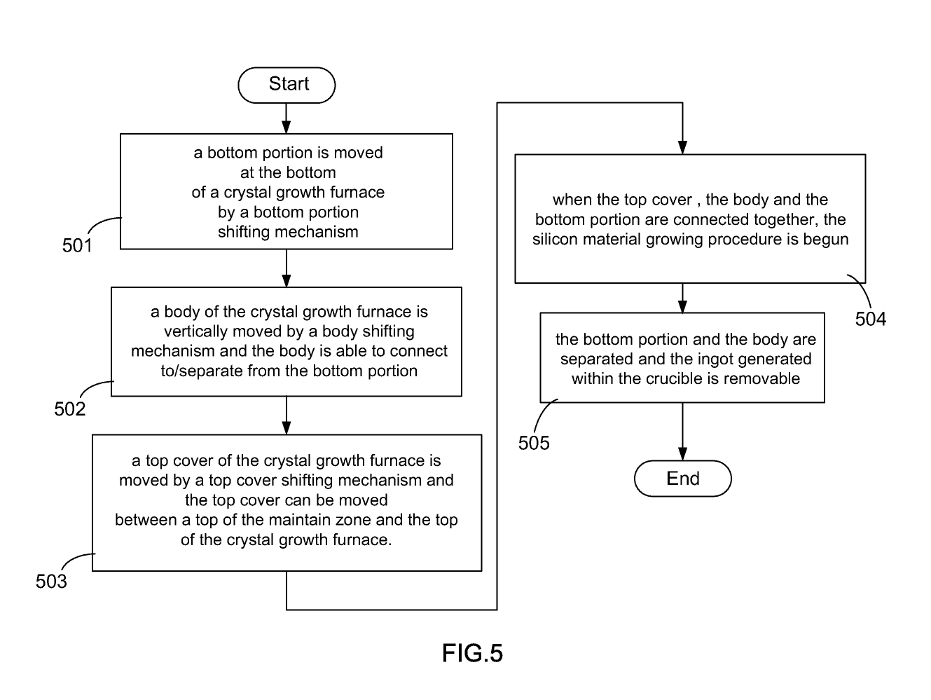

Besides, there is a moving method disclosed in the present invention. Please referring to FIG. 5, it is a flow chart illustrating a moving method of the crystal growth furnace in the present invention. As shown in FIG. 5, the moving method of the crystal growth furnace includes the following steps (the elements and the numbers described in the following description are shown in FIG. 2):

At first, in step 501, the bottom portion 114 is moved at the bottom of the crystal growth furnace 10 by the bottom portion shifting mechanism 114. The bottom portion 114 moved away from the bottom of the crystal growth furnace 10 is for engineers to remove the crucible 1162 from the crystal growth furnace 10 in an open space. Now, in step 502, the body 104 of the crystal growth furnace 10 is vertically moved by the body shifting mechanism 112 and the body 104 is able to connect to/separate from the bottom portion 106. Subsequently, in step 503, the top cover 102 of the crystal growth furnace 10 is moved by the top cover shifting mechanism 108 and the top cover 102 can be moved between the top of the maintain zone 110 and the top of the crystal growth furnace 10. When the top cover 102 is shifted to the top of the maintain zone 110, engineers are able to exam and maintain the top cover 102 in the maintain zone 110. The top cover 102 is able to connect with the body 104. In step 504, when the top cover 102, the body 104 and the bottom portion 106 are connected together, the silicon material growing procedure is begun. At final, in step 505, the bottom portion 106 and the body 104 are separated and the ingot generated within the crucible 1062 is removable.

However, in a different embodiment, the moving method of the crystal growth furnace 10 further includes the step of opening a plurality of gates in the bottom cover 116 of the bottom portion 106 to release the high temperature gas within the crystal growth furnace 10. It should be noted that there are four gates 1162 in the bottom cover 116 of the present invention and the gates 1162 are opened to form a square opening to release the heat radiation rapidly so as to reduce the temperature within the crystal growth furnace 10. In addition, the moving method of the body 104 is to activate the motor 1122 of the body shifting mechanism 112 to drive the transporting axis 1124 and the driving axis 1124 is driven the driving device 1126 to move the body 104 vertically. The purpose of moving the top cover 102 to the top of the maintain zone 110 is for engineers to maintain and moving the bottom portion 106 away from the bottom of the crystal growth furnace 10 is to remove the crucible 1062 easily. In the embodiment of the present invention, the moving method of the crystal growth furnace 10 further includes the step of separating the top cover 102 and the body 104 by moving the top cover 102 in accordance with the shifting device 1084.

Consequently, the crystal growth furnace 10 and the method thereof are clearly described in the previous chapters. According to the description above, there are several advantages in the present invention.

(1) The top cover, the body and the bottom portion are configured to connect together to be a crystal growth furnace. The top cover, the body and the bottom portion in the present invention are respectively moved by the top cover shifting mechanism, the body shifting mechanism and the bottom portion shifting mechanism. The top cover can be moved to a maintain zone and the bottom portion can be moved away from the body of the crystal growth furnace. Therefore, engineers are easy to do the maintaining jobs and the crucible is convenient to be removed from the bottom portion of the crystal growth furnace.

(2) Because the bottom portion is disposed on the bottom portion shifting mechanism, the bottom portion is moved away from the crystal growth furnace by the bottom portion shifting mechanism when engineers would like to replace crucible to be a large crucible (such as a 800 Kg crucible). The work of the crucible replacing is easy to be done according to the structure of the crystal growth furnace in the present invention.

(3) The moving method of the crystal growth furnace in the present invention can provide a standard procedure for engineers and the engineers are easy to operate the procedure of the silicon growing in the crystal growth furnace.

Although specific embodiments have been illustrated and described, it will be appreciated by those skilled in the art that various modifications may be made without departing from the scope of the present invention, which is intended to be limited solely by the appended claims.

What is claimed is:

1. A crystal growth furnace, comprising:
a top cover configured to be moved by a top cover shifting mechanism;
a body configured to be moved vertically by a body shifting mechanism; and
a bottom portion configured to be moved from the bottom of the crystal growth furnace by a bottom portion shifting mechanism and used to carry a crucible;
when the top cover, the body and the bottom portion are connected together to be the crystal growth furnace, a silicon material disposed within the crucible is grown to be an ingot, and when the bottom portion is moved from the bottom of the crystal growth furnace by the bottom portion shifting mechanism and the ingot grown within the crucible is removable.

2. The crystal growth furnace of claim 1, further comprising:
a first transporting element configured to help the top cover shifting mechanism to move the top cover;
a shifting device configured to help the top cover to separate from the body; and
a second transporting element configured to help the bottom portion shifting mechanism to move the bottom portion.

3. The crystal growth furnace of claim 2, wherein the first transporting element and the second transporting element are rail track, and a first wheel of the top cover shifting mechanism and a second wheel of the bottom portion shifting mechanism are respectively moving on the first transporting element and the second transporting element.

4. The crystal growth furnace of claim 2, wherein the top cover shifting mechanism moves the top cover between the top of the crystal growth furnace and a maintain zone.

5. The crystal growth furnace of claim 2, wherein the top cover moves to the top of the maintain zone, at least one engineer exams the top cover at the maintain zone.

6. The crystal growth furnace of claim 1, wherein the bottom portion further comprising:
a bottom cover apparatus made by a plurality of gates; and
a plurality of motors respectively connected to the plurality of gates;
when the silicon material is become the ingot, the bottom cover is manipulated to drive the plurality of gates to open the plurality of gates to release the heat inside the crystal growth furnace so as to reduce the temperature of the crystal growth furnace.

7. The crystal growth furnace of claim 1, wherein the crystal growth furnace further includes a plurality of heating elements and the plurality of heating elements are respectively disposed in the top cover, the body and the bottom portion and configured to heat the crucible.

8. A crystal growth furnace, comprising:
a top cover, and a top cover shifting mechanism moves the top cover between the top of the crystal growth furnace and a maintain zone in accordance with a first transporting element;
a body, and the body can connect with and move off the top cover in accordance with a shifting device and a body shifting mechanism is configured to vertically move the body; and
a bottom portion, the bottom portion can connect with the body and a bottom shifting mechanism is configure to move the bottom portion out off the bottom of the crystal growth furnace in accordance with a second transporting element and the bottom portion is configured to carry a crucible;
when the top cover, the body and the bottom portion are connected together to be the crystal growth furnace, a silicon material disposed within the crucible is grown to be an ingot,
when the silicon material is grown to be the ingot, the top cover is separated from the crystal growth furnace by the top cover shifting mechanism, the body is vertical moved up by the body shifting mechanism, and the bottom portion is moved away from the bottom of the crystal growth furnace by the bottom portion shifting mechanism, therefore the crucible with the ingot is easy to move away and the crucible is replaced with a new one.

9. The crystal growth furnace of claim 8, wherein the first transporting element and the second transporting element are rail tracks.

10. The crystal growth furnace of claim 8, wherein the bottom portion further comprising:
a bottom cover apparatus made by a plurality of gates; and
a plurality of motors respectively connected to the plurality of gates;
when the silicon material is become the ingot, the bottom cover is manipulated to drive the plurality of gates to open the plurality of gates to release the heat inside the crystal growth furnace so as to reduce the temperature of the crystal growth furnace.

11. The crystal growth furnace of claim 8, wherein the crystal growth furnace further includes a plurality of heating elements and the plurality of heating elements are respectively disposed in the top cover, the body and the bottom portion and configured to heat the crucible.

12. The crystal growth furnace of claim 8, wherein the body includes:
at least one motor;
at least one transporting axis connected to the motor; and
at least one driving device respectively connected to the body and the transporting axis;
wherein the motor rotates the transporting axis to move the driving device and the driving device moves the body.

13. A crystal growth furnace moving method, comprising:
moving a bottom portion at the bottom of the crystal growth furnace by a bottom portion shifting mechanism;
vertically moving a body by a body shifting mechanism to connect with and separate from the bottom portion;
moving a top cover by a top cover shifting mechanism at the top of the crystal growth furnace and a maintain zone;
connecting the bottom portion, the body and the top cover to grow a silicon material; and
separating the bottom portion and the body to take out an ingot generated within a crucible.

14. The moving method of claim 13, further comprising open a plurality of gates of a bottom cover to release high temperature within the crystal growth furnace.

15. The moving method of claim 13, further comprising:
activating at least one motor of the body shifting mechanism to drive at least one transporting axis; and
rotating the transporting axis to move the body.

16. The moving method of claim 13, further comprising moving the top cover to the top of the maintain zone for at least one engineer to maintain the crystal growth furnace.

17. The moving method of claim 13, further comprising moving the bottom portion away the bottom of the crystal growth furnace so as to take off the crucible.

18. The moving method of claim 13, further comprising moving the top cover by a shifting device to separate the top cover and the body.
